(19) United States
(12) Patent Application Publication
(10) Pub. No.: US 2025/0247016 A1
(43) Pub. Date: Jul. 31, 2025

(54) CASCADED QUASI-TWO-LEVEL CONVERTER

(71) Applicant: The Florida State University Research Foundation, Inc., Tallahassee, FL (US)

(72) Inventors: Hui Li, Tallahassee, FL (US); Jun Wang, Tallahassee, FL (US)

(21) Appl. No.: 19/041,009

(22) Filed: Jan. 30, 2025

Related U.S. Application Data
(60) Provisional application No. 63/626,849, filed on Jan. 30, 2024.
(60) Provisional application No. 63/550,221, filed on Feb. 6, 2024.

(51) Int. Cl. H02M 7/483; H02M 1/00; H02M 1/32; H02M 7/5387

(52) U.S. Cl. CPC H02M 7/4835; H02M 1/007; H02M 1/32; H02M 7/53871

(57) ABSTRACT

Systems, devices, and methods of a cascaded quasi two-level (CQ2L) converter are described herein.

### CROSS REFERENCE TO RELATED APPLICATIONS

This application claims priority to and benefit of U.S. provisional patent application Ser. No. 63/626,849 filed Jan. 30, 2024, and U.S. provisional patent application Ser. No. 63/550,221 filed Feb. 6, 2024, each of which are fully incorporated by reference in their entireties and made a part hereof.

### BACKGROUND

Existing voltage source converter high-voltage direct current (VSC-HVDC) topologies include the two-level (2L)-VSC (or 3L-VSC occasionally), and the modular multilevel converter (MMC). 2L-VSCs require devices in series (requiring device voltage balancing and slow switching) to withstand HVDC voltages and bulky harmonic filters due to its high total harmonic distortion (THD) of alternating-current (ac) voltages. On the contrary, MMC leverages submodules in series instead of devices in series (no need for device voltage balancing) and produce nearly ideal sinusoidal ac voltages to eliminate the bulky harmonic filters. Therefore, MMC features lower size and weight than 2L-VSC at the same HVDC voltage and power ratings and are more suitable for offshore HVDC substations where high volumetric and gravimetric power densities are highly demanded. Nearly all existing offshore HVDC substations use the MMC topology.

However, current state-of-the-art (SoA) HVDC substation ratings are limited to ±525 kV and 2 GW owing to the confined space and carrying capacity and high construction and handling costs of an offshore wind substation platform. To transmit a higher power at a higher voltage, the power densities of the substation must be further boosted, and the overall system cost must be reduced. The key technical barriers to higher power densities and lower cost include but are not limited to the following challenges (1) Requiring large submodule capacitor volume and weight due to the higher capacitor rms current (loss) and capacitance (energy). The high rms current (loss) is often the dominant factor that determines the capacitor size (for MMC only). (2) Requiring bulky arm inductors to suppress the circulating currents of low-order harmonics within phase-legs (for MMC only). (3) Inability to leverage high-frequency devices (e.g., SiC MOSFETs) to reduce capacitors or ac voltage harmonics (for MMC only). (4) Requiring bulky 60 Hz (or 50 Hz) step-up transformers (XFMRs) that are extremely difficult and pricy to build and handle offshore (for both MMC and 2L-VSC). (5) All the above resulting in large, heavy, and pricy offshore platform.

Therefore, systems, methods and devices are desired that overcome challenges in the art, some of which are described above.

### SUMMARY

Systems, devices, and methods are described herein that overcome the above-described disadvantages. Embodiments of the disclosed cascaded quasi-two level converter described herein address the above challenges by leveraging the advantages of both 2L-VSC and MMC topologies, including a disclosed CQ2L converter featuring full modularity that uses submodules in series instead of devices in series (like MMC); a disclosed CQ2L converter producing high-order multilevel ac distribution voltages with minimized THD to miniaturize or eliminate bulky ac filters (like MMC); a disclosed CQ2L converter having Q2L switching transients (small staircases) to mitigate the overvoltage caused by cable reflection due to the high dv/dt of fast switching semiconductor devices and long cable length, which alleviate the insulation voltage stress of filter inductors or transformers interfaced with the converter (like MMC); a disclosed CQ2L featuring redundancy (e.g., “n+1” redundancy) and fault tolerance (if using full-bridge submodules) (like MMC); with the disclosed CQ2L converter submodule embodiments, capacitors only conduct during the Q2L switching transients (small staircases), so their rms current (loss) and capacitance (energy) can be nearly 10% of MMC capacitors, which leads to a significant volume and weight reduction (like 2L-VSC); a disclosed CQ2L converter has no circulating current, so it does not need the bulky arm inductors to suppress circulating currents (like 2L-VSC); and a disclosed CQ2L converter's harmonic performance is highly associated with the switching frequency, so the disclosed CQ2L can notably benefit from fast switching devices (e.g., SiC MOSFETs). For instance, compared to the SoA MMC, the step-up XFMRs and offshore ac distribution based on CQ2L can be as high as 400 Hz to reduce all step-up XFMR size and weight (like 2L-VSC).

In one aspect, a cascaded quasi two-level (CQ2L) converter is disclosed. One embodiments of the CQ2L converter comprises a plurality of multiple quasi-two-level (Q2L) converters, each Q2L converter comprising a plurality (e.g., three) ac phase-legs connected to ac terminals of each Q2L converter, each ac phase-leg having an upper Q2L arm and a lower Q2L arm, and each Q2L arm comprised of a plurality (n) of series-connected half-bridge submodules (HBSMs) comprised of semiconductor devices including switches S1 and S2 and a submodule capacitor Cₛₘ, each HBSM having parasitic inductance, wherein the upper Q2L arm and the lower Q2L arm each produce a quasi-two-level arm voltage, which resembles a two-level voltage source converter (2L-VSC) but includes small staircases by slight control pulse delays between HBSMs such that the small staircases effectively turn the two-levels into (n+1) levels.

In some instances, the semiconductor devices that comprise each HBSM of the CQ2L converter comprise a Si or a SiC semiconductor device.

In some instances of the CQ2L converter, a dwell time of each staircase is controlled to mitigate an overvoltage caused by cable reflection due to the high dv/dt of fast switching semiconductor devices and long cable length, which alleviates the insulation voltage stress of inductors or transformers interfaced with the converter.

In some instances of the CQ2L converter, currents in the upper Q2L arm and/or the lower Q2L arm resemble chopped currents of a 2L-VSC, but they are never completely discontinued (which is the case of a 2L-VSC) because the switch device S2 and submodule capacitor Cₛₘ of each HBSM preserve a current conduction path.

In some instances of the CQ2L converter, current ratings of S1 and S2 in each of the HBSM are not identical, S1 is a main switch that conducts most current when the arms are conducting, but S2 is the auxiliary switch that conducts only during a dwell time of the Q2L staircases. In some instances, Cₛₘ conducts the same current as S2 such that the rms current and capacitance values of Cₛₘ are also quite low.

In some instances of the CQ2L converter, the CQ2L converter is comprised of an even number (2N) of the Q2L converters for de voltage symmetry connected at both dc and ac terminals by different configurations. In some instances, the Q2L converters dc terminals are directly connected in series, and the Q2L ac terminals are connected through a same number (2N) of three-phase transformers (XFMRs), with isolation. In some instances, at the Q2L side of each of the XFMRs, the XFMR windings are configured as a standard “delta” connection or a “wye” connection or any other phase angles, and at the other side of the XFMRs, all windings of all the XFMRs are configured as a big “WYE” connection with a single joint to cascade the winding voltages. In some instances, the CQ2L configuration enables a synthesis of the ac voltages of different Q2L converters with interleaved carrier phase angles and XFMR phase angles (at the Q2L side) to produce high-order multilevel ac distribution voltages with minimized total harmonic distortion (THD), and miniaturizes or eliminates bulky ac filters to reduce the overall converter size and weight.

In some instances of the CQ2L converter, each HBSM comprises full-bridge submodules; and/or each of the semiconductor devices comprises Si or WBG; IGBT, IGCT, or MOSFET, unidirectional or bidirectional, semiconductors devices; and/or different XFMR winding configurations and phase shift angles are used at the Q2L side; and/or different modulation techniques are used for the Q2L converters (e.g., phase shift PWM with different interleaved carrier phase angles, selected harmonic elimination PWM).

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an exemplary CQ2L converter topology and associated waveforms.

FIG. 2A illustrates an application of a conventional MMC.

FIG. 2B illustrates an application of an embodiment of the disclosed CQ2L converter.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising”, and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. As used herein, “exemplary” means an example of and is not intended to denote a preference or a preferred embodiment. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

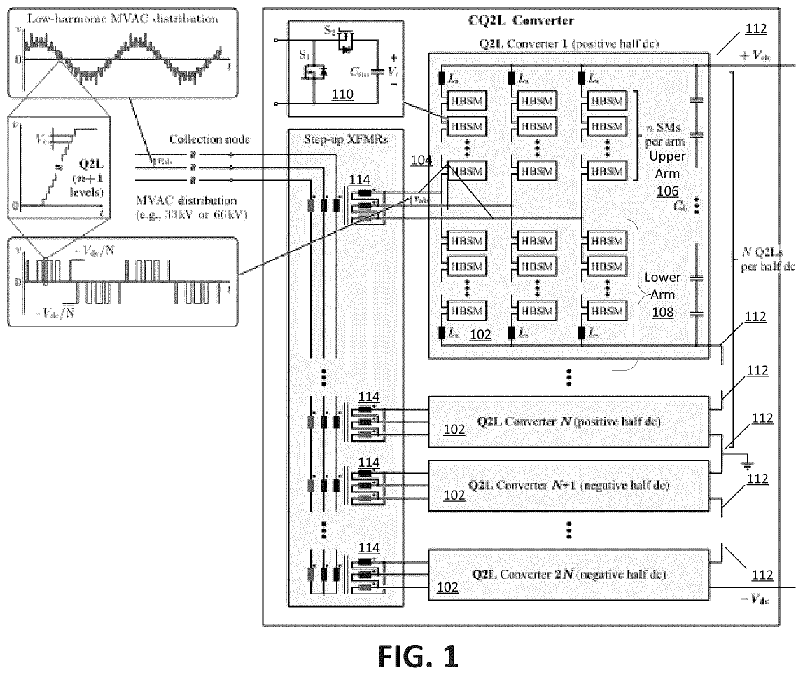

The exemplary CQ2L converter topology as illustrated in FIG. 1, is comprised of multiple quasi-two-level (Q2L) converters 102. Each Q2L 102 comprises a plurality of (e.g., three) ac phase-legs connected to the ac terminals 104 of each Q2L converter 102; each phase-leg has an upper Q2L arm 106 and a lower Q2L arm 108; and each Q2L arm is comprised of a plurality (n) of series-connected half-bridge submodules (HBSMs) 110 using semiconductor (e.g., either Si or SiC) devices along with parasitic inductance Ls. The Q2L arms 106, 108 each produce a quasi-two-level arm voltage, which resembles a two-level voltage source converter (2L-VSC) but includes small staircases by slight control pulse delays between HBSMs 110. The small staircases turn the two-levels into (n+1) levels, in effect. The dwell time of each staircase is controlled to mitigate the overvoltage caused by cable reflection due to the high dv/dt of fast switching semiconductor devices and long cable length, which alleviate the insulation voltage stress of inductors or transformers interfaced with the converter. On the other hand, the Q2L arm currents resemble the chopped currents of a 2L-VSC, but they are never completely discontinued (which is the case of a 2L-VSC) because the switch device S2 and submodule capacitor Cₛₘ preserve the current conduction path. The current ratings of S1 and S2 in each of the HBSM 110 are not identical. S1 is the main switch that conducts most current when the arms are conducting, but S2 is the auxiliary switch that conducts only during the dwell time of the Q2L staircases. Since Cₛₘ conducts the same current as S2, the rms current and capacitance value of Cₛₘ are also quite low.

The CQ2L converter topology cascades several (typically an even number 2N for dc voltage symmetry) Q2L converters 102 at both dc and ac terminals by different configurations. The Q2L converters dc terminals 112 are directly connected in series, and the Q2L ac terminals 104 are connected through the same number (2N) of three-phase transformers (XFMRs) 114, with isolation. At the Q2L side of the XFMRs, the XFMR windings are configured as the standard “delta” connection or “wye” connection or any other phase angles. At the other side of the XFMRs, all windings of all XFMRs are configured as a big “WYE” connection with a single joint to cascade the winding voltages. Such CQ2L topological configurations enable the synthesis of the ac voltages of different Q2L converters with interleaved carrier phase angles and XFMR phase angles (at the Q2L side) to produce high-order multilevel ac distribution voltages with minimized total harmonic distortion (THD). This miniaturizes or eliminates bulky ac filters to reduce the overall converter size and weight.

The CQ2L converter configuration shown in FIG. 1 can be varied by one or more of: (1) using different submodule circuits (e.g., full-bridge submodules); using different semiconductor device types (Si or WBG; IGBT, IGCT, or MOSFET; unidirectional or bidirectional, etc.) in the submodules; using different XFMR winding configurations and phase shift angles at the Q2L side; and/or using different modulation techniques for the Q2L converters (e.g., phase shift PWM with different interleaved carrier phase angles, selected harmonic elimination PWM). These and other obvious variations are considered to be within the scope of this disclosure as various embodiments of the disclosed CQ2L converter.

Unlike conventional CQ2L converters, the disclosed of CQ2L converter comprises a topology that cascades multiple Q2L converters 102. The dc terminals of each Q2L converter 102 are directly connected in series, and the three-phase ac terminals of each Q2L converter 102 are connected through multiple XFMRs 114 with their winding configured as shown in FIG. 1.

This disclosed topology is suitable for VSC-HVDC applications, particularly VSC-HVDC substations for offshore wind farms where high volumetric and gravimetric power densities are highly demanded. For example, the ongoing TenneT 2GW Program for a meshed offshore HVDC grid in the North Sea.

Conventional VSC-HVDC topologies mainly include the 2L-VSC (or 3L-VSC occasionally) and the modular multilevel converter (MMC). 2L-VSCs require devices in series (requiring device voltage balancing and slow switching) to withstand HVDC voltages and bulky harmonic filters due to its high THD of ac voltages. On the contrary, MMC leverages submodules in series instead of devices in series (no need for device voltage balancing) and produce nearly ideal sinusoidal ac voltages to eliminate the bulky harmonic filters. Therefore, MMC features lower size and weight than 2L-VSC at the same HVDC voltage and power ratings and are more suitable for offshore HVDC substations where high volumetric and gravimetric power densities are highly demanded. Nearly all existing offshore HVDC substations use the MMC topology.

However, the state-of-the-art (SoA) HVDC substation ratings are limited to ±525 kV and 2 GW owing to the confined space and carrying capacity and high construction and handling costs of an offshore wind substation platform. To transmit a higher power at a higher voltage, the power densities of the substation must be further boosted, and the overall system cost must be reduced. The key technical barriers to higher power densities and lower cost include (1) requiring large submodule capacitor volume and weight due to the higher capacitor rms current (loss) and capacitance (energy). The high rms current (loss) is often the dominant factor that determines the capacitor size (for MMC only). (2) requiring bulky arm inductors to suppress the circulating currents of low-order harmonics within phase-legs (for MMC only). (3) an inability to leverage high-frequency devices (e.g., SiC MOSFETs) to reduce capacitors or ac voltage harmonics (for MMC only). (4) requiring bulky 60 Hz (or 50 Hz) step-up XFMRs that is extremely difficult and pricy to build and handle offshore (for both MMC and 2L-VSC). All the above results in large, heavy, and pricy offshore platform installations.

Advantageously, embodiments of the disclosed CQ2L converter addresses all these barriers by leveraging the advantages of both 2L-VSC and MMC topologies. The disclosed CQ2L converter features full modularity that uses submodules in series instead of devices in series. (like MMC). The disclosed CQ2L converter produces high-order multilevel ac distribution voltages with minimized THD to miniaturize or eliminate bulky ac filters. (like MMC). The disclosed CQ2L converter has Q2L switching transients (small staircases) to mitigate the overvoltage caused by cable reflection due to the high dv/dt of fast switching semiconductor devices and long cable length, which alleviate the insulation voltage stress of filter inductors or transformers interfaced with the converter. (like MMC). The disclosed CQ2L converter features redundancy (e.g., “n+1” redundancy) and fault tolerance (if using full-bridge submodules). (like MMC). The submodule capacitors of the disclosed CQ2L converter only conduct during the Q2L switching transients (small staircases), so their rms current (loss) and capacitance (energy) can be as low as 10% of MMC capacitors. This will lead to a significant volume and weight reduction (like 2L-VSC). The disclosed CQ2L converter has no circulating current, so it does not need the bulky arm inductors to suppress circulating currents. (like 2L-VSC).

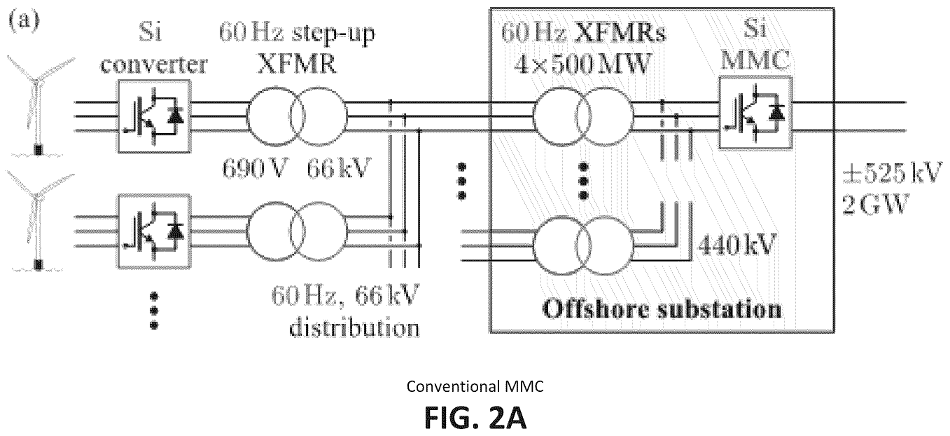

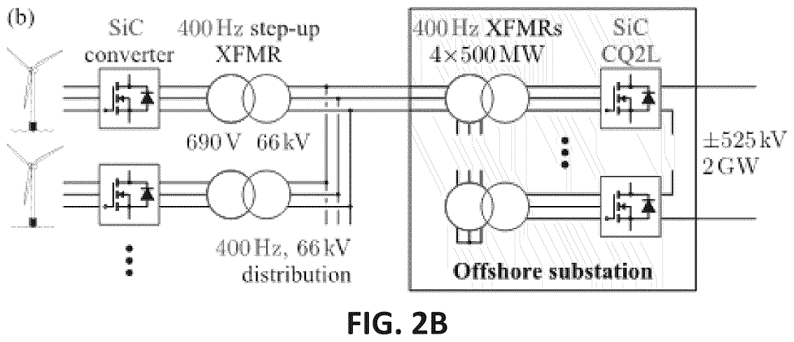

The disclosed CQ2L's harmonic performance is highly associated with the switching frequency, so the disclosed CQ2L benefits from fast switching devices (e.g., SiC MOSFETs). For instance, comparing the conventional MMC (FIG. 2A) to the disclosed CQ2L converter shown in FIG. 2B, it can readily be seen that the step-up XFMRs and offshore ac distribution based on the disclosed CQ2L converter (FIG. 2B) can be as high as 400 Hz to reduce all step-up XFMR size and weight (like 2L-VSC).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A cascaded quasi two-level (CQ2L) converter, comprising:
a plurality of quasi-two-level (Q2L) converters, each Q2L converter comprising three ac phase-legs connected to ac terminals of each Q2L converter, each ac phase-leg having an upper Q2L arm and a lower Q2L arm, and each Q2L arm comprised of a plurality (n) of series-connected half-bridge submodules (HBSMs) comprised of semiconductor devices including switches S1 and S2 and a submodule capacitor Cₛₘ, each HBSM having parasitic inductance, wherein the upper Q2L arm and the lower Q2L arm each produce a quasi-two-level arm voltage, which resembles a two-level voltage source converter (2L-VSC) but includes small staircases by slight control pulse delays between HBSMs such that the small staircases effectively turn the two-levels into (n+1) levels.

2. The CQ2L converter of claim 1, wherein each of the semiconductor devices comprising each HBSM is either a Si or a SiC semiconductor device.

3. The CQ2L converter of claim 1, wherein a dwell time of each staircase is controlled to mitigate an overvoltage caused by cable reflection due to the high dv/dt of fast switching semiconductor devices and long cable length, which alleviates the insulation voltage stress of inductors or transformers interfaced with the converter.

4. The CQ2L converter of claim 1, wherein currents in the upper Q2L arm and/or the lower Q2L arm resemble chopped currents of a 2L-VSC, but they are never completely discontinued (which is the case of a 2L-VSC) because the switch device S2 and submodule capacitor Cₛₘ of each HBSM preserve a current conduction path.

5. The CQ2L converter of claim 1, wherein current ratings of S1 and S2 in each of the HBSM are not identical, S1 is a main switch that conducts most current when the arms are conducting, but S2 is the auxiliary switch that conducts only during a dwell time of the Q2L staircases.

6. The CQ2L converter of claim 5, wherein Cₛₘ conducts the same current as S2 such that the rms current and capacitance values of Cₛₘ are also quite low.

7. The CQ2L converter of claim 1, wherein the CQ2L converter is comprised of an even number (2N) of the Q2L converters for dc voltage symmetry connected at both dc and ac terminals by different configurations.

8. The CQ2L converter of claim 7, wherein the Q2L converters de terminals are directly connected in series, and the Q2L ac terminals are connected through a same number (2N) of three-phase transformers (XFMRs), with isolation.

9. The CQ2L converter of claim 8, wherein at the Q2L side of each of the XFMRs, the XFMR windings are configured as a standard “delta” connection or a “wye” connection or any other phase angles, and at the other side of the XFMRs, all windings of all the XFMRs are configured as a big “WYE” connection with a single joint to cascade the winding voltages.

10. The CQ2L converter of claim 9, wherein the CQ2L configuration enables a synthesis of the ac voltages of different Q2L converters with interleaved carrier phase angles and XFMR phase angles (at the Q2L side) to produce high-order multilevel ac distribution voltages with minimized total harmonic distortion (THD), and miniaturizes or eliminates bulky ac filters to reduce the overall converter size and weight.

11. The CQ2L converter of claim 8, wherein each XFMR is rated for operation at greater than 60 Hz.

12. The CQ2L converter of claim 11, wherein each XFMR is rated for operation at 400 Hz.

13. The CQ2L converter of claim 1, wherein:
(1) each HBSM comprises full-bridge submodules; and/or
(2) each of the semiconductor devices comprises Si or WBG; IGBT, IGCT, or MOSFET, unidirectional or bidirectional, semiconductors devices; and/or
(3) different XFMR winding configurations and phase shift angles are used at the Q2L side; and/or
(4) different modulation techniques are used for the Q2L converters (e.g., phase shift PWM with different interleaved carrier phase angles, selected harmonic elimination PWM).
